(19) United States
(12) Patent Application Publication
(10) Pub. No.: US 2025/0342394 A1
(43) Pub. Date: Nov. 6, 2025

(54) PRODUCING AN AUGMENTED DATASET TO IMPROVE PERFORMANCE OF A MACHINE LEARNING MODEL

(71) Applicant: ZETANE SYSTEMS INC., Kirkland (CA)

(72) Inventor: Patrick ST-AMANT, Saint-Lazare (CA)

(21) Appl. No.: 18/861,034

(22) PCT Filed: Apr. 28, 2023
(86) PCT No.: PCT/CA2023/050580

§ 371 Date: Oct. 28, 2024

Related U.S. Application Data
(60) Provisional application No. 63/337,144, filed on May 1, 2022.

(51) Int. Cl. G06N 20/00

(52) U.S. Cl. CPC G06N 20/00

(57) ABSTRACT

Producing an augmented dataset to improve performance of a machine learning model. A test series is created for a first type of data transformation. the test series defining a set of test values for at least one parameter characterizing the first type of data transformation. Test datasets are generated based on a source dataset, each of the test datasets corresponding to a respective test value of the set of test values for said at least one parameter characterizing the first type of data transformation. Each of the test datasets is input to the machine learning model to produce a corresponding model output. At least one score is determined for each test dataset based at least in part on the corresponding model output. Robustness metrics of the first type of data transformation are determined based on a function which maps said at least one score of each of the test datasets to said at least one parameter characterizing the first type of data transformation. A set of one or more data augmentations are determined to be applied to the source dataset based at least in part on said one or more robustness metrics of the first type of data transformation. An augmented dataset is generated based on the source dataset using the determined set of one or more data augmentations.

This patent application claims priority to U.S. provisional patent application 63/337,144 filed May 1, 2022.

### TECHNICAL FIELD

The present disclosure relates to improving performance of a machine learning model.

### BACKGROUND

In the field of machine learning (ML) and artificial intelligence (AI), data scientists train machine learning models to make predictions. After these models are trained and scored using metrics such as accuracy, precision, F1 score or recall, it is often difficult to understand what are the next steps to improve the performance of the model with regards to the dataset. Whether the results acceptable with regard to these metrics, the project supervisor, clients or other stakeholders may ask questions to understand the limitations of the ML solution and how to improve it further. These discussions between the data scientist and stakeholders are often tedious because both the model and dataset are handled as black boxes.

To get deep insight into an ML solution, fairly extensive scripts must be written specifically for the solution and non-interactive, often incomplete reports are created to support to support the solution. Because of this, and the lack of actionable information about fine-grained model performances and the boundary of operations of the model, AI solutions fail to be deployed or fail in deployment.

Open-source repositories, such as the Tensorflow-Keras and Pytorch frameworks, offer functionalities which allow users to augment datasets with the objective of improving the performance of a model. However, these conventional tools do not provide for automatically testing the robustness of a model in a fully integrated way. Moreover, such approaches are typically specific to a particular model or application. For example, there are “explainable AI” libraries such as Gradcam, which allow data scientists to gain some insight for specific model or solution, but the code written for these tools cannot easily be used directly on another solution.

### SUMMARY

The present disclosure relates to a system, and interface, to generate highly detailed and interactive reports which are needed to ensure validation of a model, especially in high-risk industries. Disclosed embodiments provide for evaluating the boundary of an AI solution and model and automatically scoring and evaluating the robustness of a model for a large number of test types. Disclosed embodiments can accelerate evaluation of model performance, reduce the computation time of such testing and evaluation using parallel computing, and provide interactive and detailed report for many types of users. The approaches described herein allow data scientists and other stakeholders to deeply assess the suitability of a model for specific target applications. Disclosed embodiments further provide for sorting test results according to new “robustness” metrics and gathering easy-to-access information in detailed and interactive reports.

Disclosed embodiments generate data augmentations aimed at improving a dataset and associated model. Specifically, the approaches described herein provide automation to create a large number of specific test datasets to create metrics, e.g., in graphical form, for evaluating the performance of a model, which makes it possible to identify and recommend techniques for improving a particular dataset and model. These tools provide the ability to deploy safe and audited models in the real world.

In one aspect, the disclosed embodiments are directed to a method to produce, using at least one computer having one or more processors and memory, an augmented dataset to improve performance of a machine learning model. The method includes creating a test series for a first type of data transformation, the test series defining a set of test values for at least one parameter characterizing the first type of data transformation. The method further includes generating test datasets based on a source dataset, each of the test datasets corresponding to a respective test value of the set of test values for said at least one parameter characterizing the first type of data transformation. The method further includes inputting each of the test datasets to the machine learning model to produce a corresponding model output. The method further includes determining at least one score for each test dataset based at least in part on the corresponding model output. The method further includes determining one or more robustness metrics of the first type of data transformation based on a function which maps said at least one score of each of the test datasets to said at least one parameter characterizing the first type of data transformation. The method further includes determining a set of one or more data augmentations to be applied to the source dataset based at least in part on said one or more robustness metrics of the first type of data transformation. The method further includes generating an augmented dataset based on the source dataset using the determined set of one or more data augmentations.

Embodiments may include one or more of the following features.

In creating the test series for the first type of data transformation, the set of test values may be defined by a selected range minimum, a selected range maximum, and a selected number of intervals of said at least one parameter. The set of test values may be defined by a user specifying each value of the set of test values. The test series may include data objects, each of the data objects specifying the first type of data transformation and including said at least one parameter characterizing the first type of data transformation, wherein values of said at least one parameter in the data objects define the set of test values. The first type of data transformation may be in one or more of the following categories: blur, color correction, domain adaptation, zoom, weather, noise, translation, rotation, occlusion, enhancement, pixel attack, ethics, drift, statistics, and global explainable artificial intelligence (xAI). The first type of data transformation may include one or more of the following: rotate, blur, random shadow, sharpen and darken, random grid shuffle, gaussian noise, motion blur, horizontal flip, vertical flip, horizontal and vertical flip, sun flare, contrast raise, brightness raise, brightness reduce, desert domain adaptation, winter domain adaptation, jungle domain adaptation, red shift, green shift, blue shift, yellow shift, magenta shift, cyan shift, translate horizontal, translate vertical, translate horizontal reflect, translate vertical reflect, shot noise, impulse noise, defocus blur, snow, frost, fog, brightness, contrast, elastic transform, pixelate, jpeg compression, zoom center, zoom right, zoom left, zoom top, zoom bottom, zoom right bottom, zoom right top, zoom left bottom, and zoom left top.

In generating the test datasets based on the source dataset, the source dataset may include one or more of: images, texts, tabular data, hierarchical data, graphs, videos, 3-D meshes, signals, and multidimensional arrays.

In determining said at least one score for each test dataset, said at least one score may be indicative of one or more of the following: accuracy, F1 score, precision, and recall. The score may be based at least in part on ground truth. The ground truth may be retrieved from the source dataset. The score may be indicative of one or more evaluation metrics.

In determining said one or more robustness metrics of the first type of data transformation, said one or more robustness metrics may be determined based on an area under the function as the function is plotted versus said at least one parameter characterizing the first type of data transformation. The area under the function may be weighted based on said at least one parameter characterizing the first type of data transformation. The robustness metrics may be determined based on one or more values of slope of the function as the function is plotted versus said at least one parameter characterizing the first type of data transformation.

In determining the set of one or more data augmentations to be applied to the source dataset based at least in part on said one or more robustness metrics of the first type of data transformation, one or more processes may be used to augment the source data set, the augmented dataset may be used to retrain the machine learning model, and, if performance of the model increases, then the augmented dataset may be used as the source data set in a further iteration. The one or more robustness metrics of the first type of data transformation may be compared to one or more robustness metrics of at least a second type of data transformation. The robustness metrics of the first type of data transformation may be compared to one or more thresholds. The robustness metrics of the first type of data transformation may include said one or more values of the slope of the function plotted versus said at least one parameter characterizing the first type of data transformation and said one or more values of the slope are compared a maximum slope threshold. The set of one or more data augmentations may include at least one type of data transformation in addition to any type of data transformation input or selected by a user.

In generating the augmented dataset based on the source dataset using the determined set of one or more data augmentations, the augmented dataset may have one or more improved scores relative to the source dataset. The augmented dataset may have an increased number of instances relative to the source dataset. The augmented dataset may have the same number of instances as the source dataset. The method may further include processing the augmented dataset to remove one or more instances which have been found to degrade performance of the model, resulting in fewer instances than the source dataset, to improve one or more scores relative to the source dataset.

The method may further include training the machine learning model using the augmented dataset to produce a retrained machine learning model. The method may further include using the retrained machine learning model to perform on an input dataset one or more of the following: prediction, classification, object detection, and clustering.

In another aspect, the disclosed embodiments are directed to a system to produce an augmented dataset to improve performance of a machine learning model, the system comprising at least one computer having one or more processors and memory, the memory storing instructions that, as a result of execution by the one or more processors, cause the one or more processors to perform methods described above.

In another aspect, the disclosed embodiments are directed to a non-transitory computer-readable storage medium having instructions stored thereon that, when executed, cause at least one computer processor to perform the methods described above.

### BRIEF DESCRIPTION OF THE DRAWINGS

The invention will be better understood by way of the following detailed description of embodiments of the invention with reference to the appended drawings, in which:

FIGS. 1 and 2 depict data flow in a system to produce an augmented dataset adapted to improve performance of a machine learning model and to use the improved model to perform tasks on an input dataset.

FIGS. 3 and 4 depict a graphical user interface of the test and evaluation platform which allows a user to specify one or more tests to be performed.

FIG. 5 depicts a graphical user interface of the test and evaluation platform which allows a user to specify a composed test formed one or more individual tests to be performed.

FIG. 6 is a flow diagram for a method to produce an augmented dataset adapted to improve performance of a machine learning model.

FIGS. 7 and 8 depict plots of a function which maps values of the score for each of a number of test datasets to the parameter (or parameters) characterizing the data transformation.

FIG. 9 depicts an example of code to determine robustness metrics using, for example, Python script.

FIG. 10 depicts an example of code to perform dataset enrichment to generate an augmented dataset from the source dataset.

FIG. 11 depicts an example of code to perform on-the-fly augmentation to generate an augmented dataset from the source dataset.

FIG. 12 depicts a graphical user interface presenting metrics for the performance of the machine learning model.

FIG. 13A is a block diagram of an example of a computing system usable to implement methods described herein.

FIG. 13B is a block diagram of an example of machine vision system used in product manufacturing.

FIG. 14 depicts a graphical user interface showing navigation and filtering of instances of a dataset.

FIG. 15 depicts a graphical user interface showing detailed information for a particular instance of a dataset.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As an overview, the system may be considered to have two main components: a testing and evaluation platform and a data augmentation platform. The system can be cloud-based, on-premises server-based, or a personal computer, with or without internet connection. In embodiments, a testing and evaluation platform may provide for the selection of a machine learning model and a dataset (with or without ground truth), selection of particular specifications, and generation of an interactive visual report based on extensive and detailed computations involving extremely large quantities of data (i.e., “big data”). A data augmentation platform may provide for selection of a dataset (with or without ground truth), selection of particular specifications, and the generation of a dataset which is specifically adapted to improve the performance of a particular machine learning model.

In embodiments, the inputs to the testing and evaluation platform may be a machine learning model, a dataset (e.g., a source dataset), and “ground truth” data. In embodiments, the ground truth (i.e., annotations) may be part of the dataset. Alternatively, the ground truth may be handled as a separate input. The dataset may comprise elements such as images, text, tabular data, hierarchical data, graphs, videos, 3-D meshes, signals, multidimensional arrays, and other types of data. In embodiments, the model may be a computer vision deep learning model (i.e., an artificial neural network). In embodiments, the model may be a machine, hardware, a system, a function, or a software module (e.g., a natual language processing model), or combinations thereof. In embodiments, the ground truth may not be needed as an input.

In embodiments, the framework (e.g., TensorFlow-Keras or PyTorch, which are open-source software libraries for machine learning and artificial intelligence), model type, e.g., image classification, image object detection, image segmentation, and image-to-image translation, can be selected or automatically detected (as well as other characteristics of the system if the model is a machine). The user can also change the sample size, i.e., the number of elements or percentage of the dataset to be used to perform the analysis which results in the creation of a report. In embodiments, models and datasets can be uploaded or transferred to a storage media or database for manipulations and ulterior use, e.g., as templates for future tests.

When deploying machine learning models in the industrial context there is a high risk of model failure and performance degradation. This is due to the discrepancies between the data used for training the model and the data inputs coming from the real-world context where the model is deployed. Industrial data is often difficult to obtain, sparse, not already annotated and expensive to develop. This means that it is often impossible to have datasets that will cover every potential event seen in the operational context. Due to this, it is important to understand the performance of the model for many transformations and identify the model's weaknesses and retrain the model with a well-prepared augmented dataset which will produce a model that can perform correctly in the required operational context.

An example of such an industrial application in the field of computer vision is the automated visual inspection of cables, wires and pipes. In the energy and oil industry, the good condition of sensor cables, electric wires and pipes is essential for safe and profitable operations. Undetected corrosion on pipes and damage to wires and cables lead to large losses in revenue. Visual inspection using computer vision models allows for automatic detection of flaws where manual inspection is not achievable due to the scale of the task and risks to human inspectors. In practice, video and image data gathering of cables, wires and pipes with multiple defects is time consuming, requires legal authorizations and hardware infrastructure. Moreover, labeling and annotating defects of video footage or images of pipelines, cables or wire needs domain experts who can often only offer limited support.

Using the present solution, it may be possible to use a small annotated dataset to generate a model which will perform under many operational contexts. A small cable, wire or pipe dataset will first be used to train a model, then the model will be evaluated to understand the degradation in performance as related to transformations such as motion blur, brightness, noise, contrast and color shifts. For example, if the performance of the model decreases by half at every step of image brightness level, then an augmentation which add images with modified brightness level to the source dataset and model retraining will be launched. The model produced by this process will then have better performance when the brightness level image varies. Thus, the model will keep operating well no matter the level of sunlight present while capturing the video or images in the field of operation or inspection drone cameras.

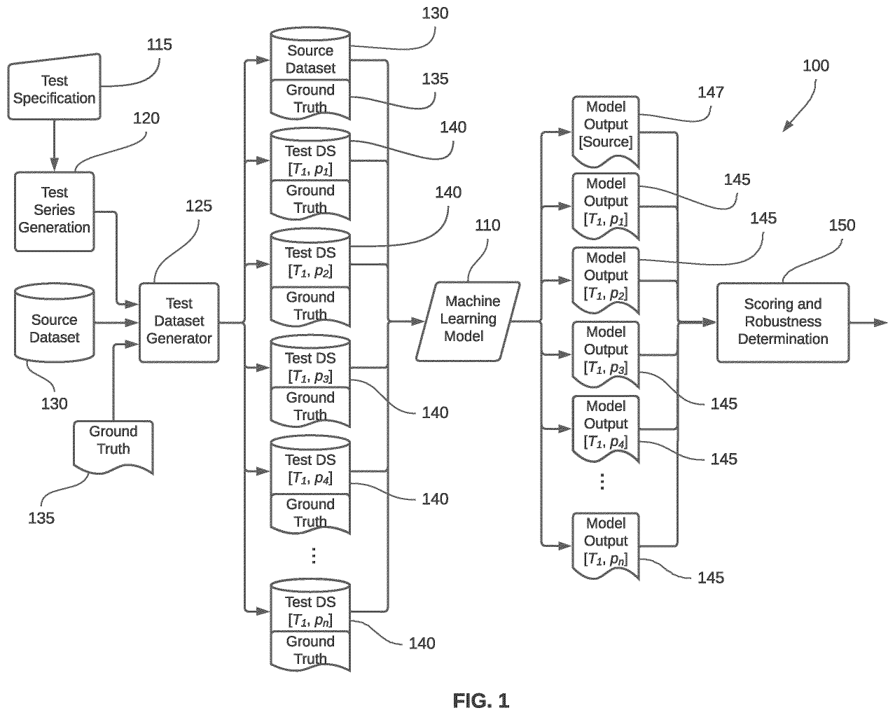

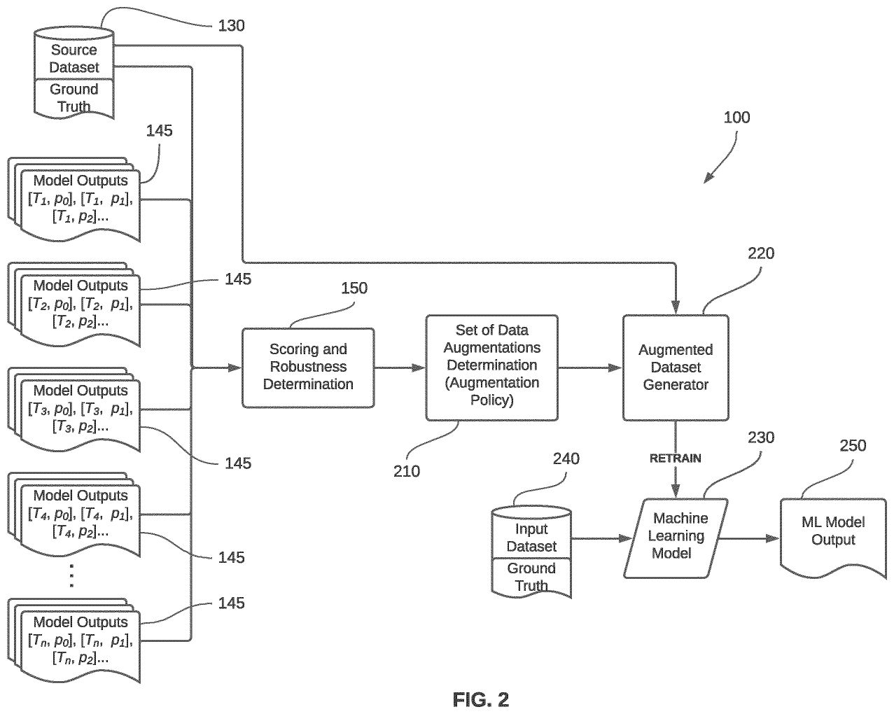

FIGS. 1 and 2 depict data flow in a system 100 to produce an augmented dataset adapted to improve performance of a machine learning model 110 and to use the improved model to perform tasks on an input dataset, such as prediction, classification, object detection, and clustering. As discussed in further detail below, the system 100 presents a graphical user interface which allows a user to define the test specification 115, including the input and/or selection of particular types of data transformations and parameters quantifying the transformations. For example, a “motion blur” test may be selected as a first test (T₁) by a user, with a specified number, n, of parameter values (p₀, p₁, p₂, p₃ . . . , Pₙ), between a specified range minimum and a specified range maximum.

The test series generator 120 accepts the test specification 115 defined by the user and produces a test series for each particular type of data transformation, e.g., blur (T₁), rotation (T₂), etc. The test series defines a set of test values for the parameter (p) (or multiple parameters) characterizing the data transformation, e.g., a parameter specifying a degree of blurring for a blur data transformation. In embodiments, the creation of the test series for the particular type of data transformation may involve the creation of data objects which specify the particular type of data transformation (Tₙ) and which include parameter values (pₙ) characterizing the particular type of data transformation. For example, the objects [motion blur, 2.1] and [motion blur, 3.2] specify “motion blur” as the particular type of data transformation and 2.1 and 3.2 are respective parameter values (pₙₚ) characterizing the motion blur transformation. In embodiments, the data objects may contain sequences of transformations, such as ([motion blur, 4.5], [red shift, 5.32]).

The test series are input to a test dataset generator 125, along with the source dataset 130 and ground truth 135 (which may be stored as part of the source dataset). Each of the test datasets 140 corresponds to a respective test value of the set of test values for the parameter (pₙ) characterizing the particular type of data transformation (Tₙ). Each of the test datasets 140 is input to the machine learning model 110 to produce a corresponding inference, i.e., a corresponding model output 145. In embodiments, the source dataset 130 is also input to the machine learning model 110 to produce a corresponding model output 147.

The model outputs 145 are analyzed in a scoring and robustness determination 150 using various algorithms to evaluate the performance of the machine learning model 110. In embodiments, a determined score may be indicative of one or more of the following evaluation metrics, e.g., accuracy, F1 score, precision, and recall. The score may be based at least in part on ground truth 135, which may be retrieved from the source dataset 130, e.g., in the form of annotations corresponding to the instances, or as a separate data structure (e.g., data file). One or more robustness metrics of the particular type of data transformation (Tₙ) based on a function which maps the score of each of the test datasets 140 to the parameter values (pₙ) characterizing the data transformation. In embodiments, the robustness metrics may be determined based on an area under the function as the function is plotted versus the parameter values (pₙ) characterizing the data transformation.

FIG. 2 depicts data flow by which (as explained above) the model outputs 145 from the machine learning model 110 for each test dataset 140 (each test dataset corresponding to a particular type of data transformation (Tₙ) and particular parameter value, pₙ) undergo a scoring and robustness determination. These results are used in a set of one or more data augmentations determination 210 to be applied to the source dataset 130 (i.e., an “augmentation policy”). As discussed in further detail below, the set of data augmentations determination 210 is based at least in part on the robustness metrics of the particular type of data transformation. The result is a set of data transformations (Tₙ), which may include tests specified by the test specification 115, to be performed to augment the source dataset 130.

An augmented dataset is generated by the augmented dataset generator 220 based on the source dataset 130 using the determined set of data augmentations 210. The machine learning model 110 may be trained using the augmented dataset to produce a retrained machine learning model 230. The retrained machine learning model 230 may be used to perform, on an input dataset 240, one or more of the following: prediction, classification, object detection, and clustering-resulting in model outputs 250 from the retrained model 230.

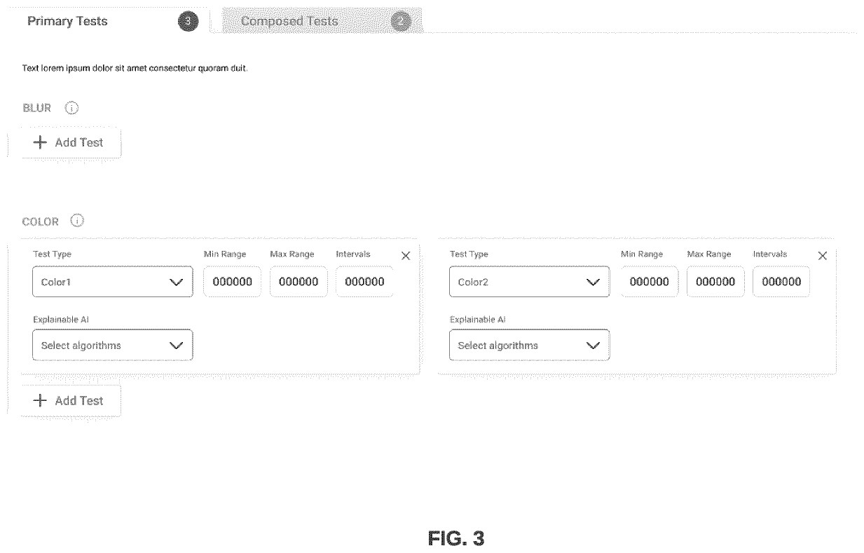

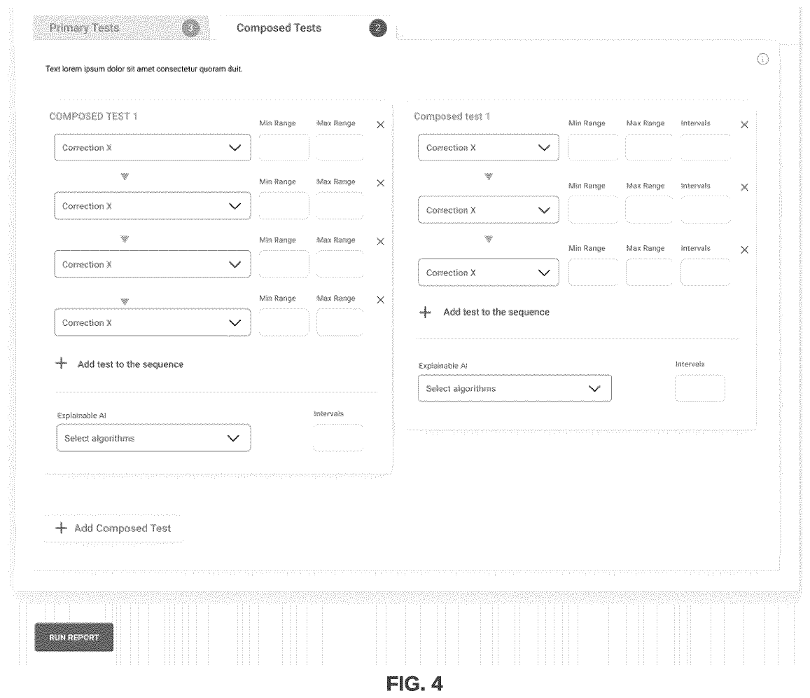

FIGS. 3 and 4 depict a graphical user interface of the test and evaluation platform which allows a user to specify one or more tests to be performed. The tests may be input or selected as primary tests in which one particular test is performed (as shown, e.g., in FIG. 3) or as composed tests which allow sequences of primary tests to be specified (as shown, e.g., in FIG. 4). In embodiments, the process may be initiated without tests being input or selected by the user, as the system will determine which tests to run based at least in part on analysis of the source dataset and/or previous iterations of the process. In embodiments, to perform a particular test, a test series may be created for a particular type of data transformation, e.g., blur, rotation, etc. The test series defines a set of test values for a parameter (or multiple parameters) characterizing the data transformation, e.g., a parameter specifying a degree of blurring for a blur data transformation. In embodiments, the set of test values may be defined by a selected range minimum, a selected range maximum, and a selected number of intervals of the parameter. Alternatively, a user may specify each individual value of the set of test values. Various other ways of defining a set of test values may be used, e.g., selecting a minimum, a step value, and the number of values in the set of test values. In embodiments, the user interface may allow for the process to be initiated without any tests being selected, in which case a report is generated to score only the source dataset. 130.

As an example, a motion blur test may be selected by a user from the blur category of tests. In defining the set of test values, the range minimum may be set to zero, the range maximum may be set to 50, and the number of intervals may be set to 10. When the report computations are launched, i.e., initiated, by a user, an array having a specified number, e.g., 10, of parameter values (p), between a specified range minimum and a specified range maximum, may be generated. The parameter values (p) may be evenly spaced between the range minimum and maximum or may have some other specified or determined spacing.

Based on the test specification 115, the system 100 generates test datasets 140 based on the source dataset 130. Each of the test datasets 140 corresponds to a respective test value of the set of test values for the parameter (p) characterizing the data transformation, e.g., blur, rotation, etc. In the context of the present example, for each test value (i.e., each value of the parameter p), a degree of blur characterized, i.e., quantified, by the parameter p is applied to each instance (e.g., each image) of the dataset to generate a new blurred dataset, i.e., a test dataset, of parameter p. In embodiments, a greater parameter value results in greater image perturbation in the test dataset. In the present example, the greater the parameter value, the more blurred the generated test dataset will be.

In the present example, the specified test series will result in the generation of ten test datasets, each comprising a blurred version of the source dataset 130 images. The test datasets 140 may be held in memory and/or stored by the system 100. As discussed in further detail below, each of the test datasets 140 is used as input to the machine learning model 110, scored, and logged in a report. These reports provide an indication of the performance of the machine learning model 110 if its input images were to be affected by a motion blur. Such reports can also serve as a way to evaluate the operational boundaries of the model 110. For example, for a particular motion blur parameter value, q, if the model 110 exhibits weak performance or performance outside of environmental and/or contextual requirements, then the model 110 would be suitable for deployment in an environment where motion blurs lower than this parameter value, q, are expected.

The user interface depicted in FIGS. 3 and 4 also allows a user to select an explainable artificial intelligence (AI) algorithm to allow the operator to understand the operating characteristics of the machine learning model 110, such as, for example, where the model 110 is focusing its attention to make a prediction. In embodiments, explainable AI algorithms can be requested to be computed for each test and for the source dataset 130.

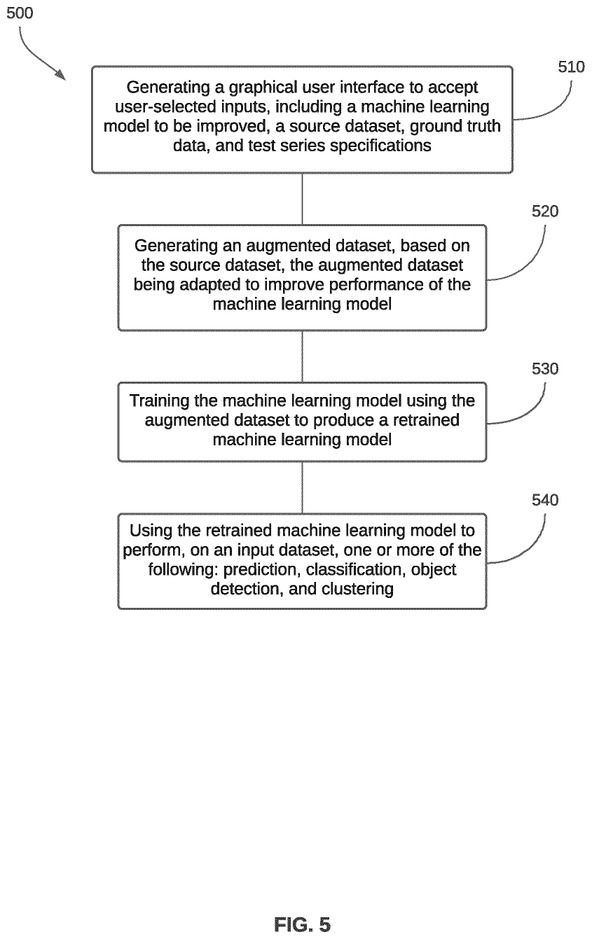

FIG. 5 depicts a graphical user interface of the test and evaluation platform which allows a user to specify a composed test formed one or more individual tests to be performed. In this way, primary tests can be composed sequentially to create composed tests. For example, a composed test of a blur followed by a redshift transformation applied to a dataset comprising images, will blur the images and shift the colors of the images towards red hues based on the specified transformation parameters. In embodiments, these test and specification selections can be saved and stored for later use as a test template. In such a case, after selecting a model and dataset, test templates can be loaded to generate a report based on predetermined specifications. This helps users to compare models and datasets based on a similar benchmark.

In embodiments, the user can select from a wide range of tests to be performed on the dataset, which may be arranged into categories, such as, for example, blur, color correction, domain adaptation, zoom, weather, noise, translation, rotation, occlusion, enhancement, pixel attack, ethics, drift, statistics, and global explainable artificial intelligence (xAI). The tests available under these categories, or in addition to these categories, may include, for example, the following: rotate, blur, random shadow, sharpen and darken, random grid shuffle, gaussian noise, motion blur, horizontal flip, vertical flip, horizontal and vertical flip, sun flare, contrast raise, brightness raise, brightness reduce, desert domain adaptation, winter domain adaptation, jungle domain adaptation, red shift, green shift, blue shift, yellow shift, magenta shift, cyan shift, translate horizontal, translate vertical, translate horizontal reflect, translate vertical reflect, shot noise, impulse noise, defocus blur, snow, frost, fog, brightness, contrast, elastic transform, pixelate, jpeg compression, zoom center, zoom right, zoom left, zoom top, zoom bottom, zoom right bottom, zoom right top, zoom left bottom, and zoom left top.

FIG. 5 is a flow diagram for a method to produce an improved machine learning model to perform tasks on an input dataset, such as prediction, classification, object detection, and clustering. The system 100 provides a graphical user interface to accept user-entered and/or user-selected inputs, including a particular machine learning model 110 to be improved, a source dataset 130, ground truth 135 data, and test series specifications (510). In embodiments, the system 100 may perform a compatibility evaluation to determine if the inputs are valid and consistent with each other. In such a case, the system 100 may produce error reports and/or confirmation messages via the user interface. The system 100 generates an augmented dataset, based on the source dataset (520). The augmented dataset is adapted to improve performance of the machine learning model 110, as discussed in further detail below. The machine learning model 110 is trained using the augmented dataset to produce a retrained machine learning model (530). The retrained machine learning model is used to perform a task on an input dataset, such as one or more of the following: prediction, classification, object detection, and clustering (540).

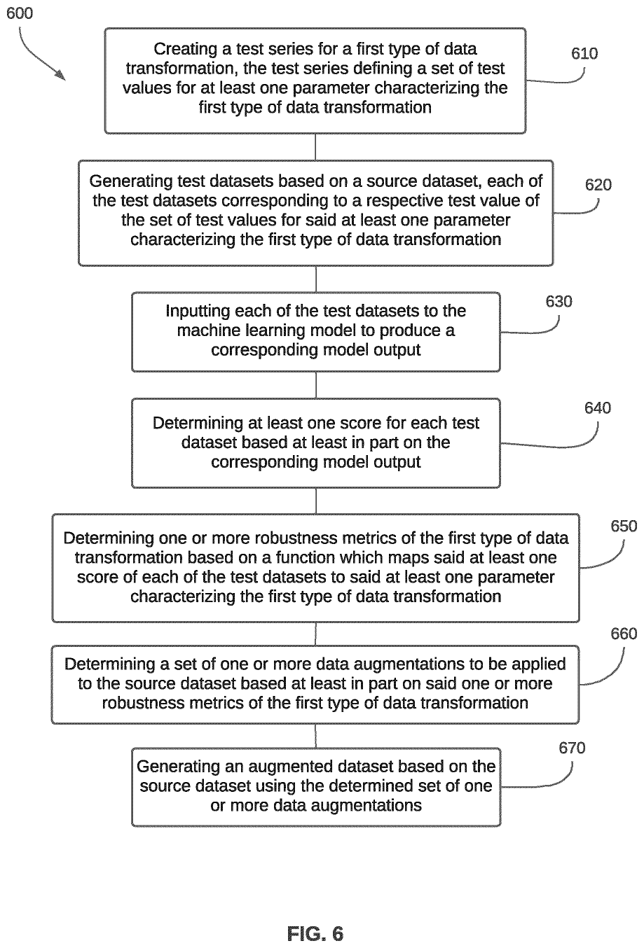

FIG. 6 is a flow diagram for a method (600) to produce an augmented dataset adapted to improve performance of a machine learning model. The method (600) includes creating a test series for a particular type of data transformation, e.g., blur, rotation, etc., depending upon inputs and/or selections made by a user (610). The test series defines a set of test values for at least one parameter characterizing the particular type of data transformation, such as, for example, a parameter quantifying the amount of blur to be applied to instances (e.g., images) of the source dataset 130. As discussed above, in the context of FIGS. 3 and 4, the system 100 presents a graphical user interface which allows a user to define the test series, and input and/or select particular types of transformations and parameters quantifying the transformations, such as, for example specified parameter values or ranges and intervals. The user interface also allows for the selection of explainable artificial intelligence (xAI) algorithms, the number of samples of the source dataset 130 to be used in the method, as well as models and/or algorithms to verify the ethical characteristics of the model 110 and source dataset 130.

In embodiments, the preparation of the test series may involve generating a sequence of parameters based on the dividing a specified range into a regular interval (i.e., step or spacing between parameter values). In such a case, the creation of the test series for the particular type of data transformation may be based on a set of test values defined by a selected range minimum, a selected range maximum, and a selected number of intervals of said at least one parameter. Alternatively, the set of test values may be defined by a user specifying each value of the set of test values.

In embodiments, the creation of the test series for the particular type of data transformation may involve the creation of data objects which specify the particular type of data transformation and which include at least one parameter characterizing the particular type of data transformation. The values of this parameter (or parameters) may define the set of test values. These data objects may contain the information needed to run the tests requested by a user, i.e., the defined test series for a particular type of data transformation, in parallel. For example, two objects, [motion blur, 2.1] and [motion blur, 3.2], where “motions blur” is the particular type of data transformation and 2.1 and 3.2 are respective values of a parameter characterizing the motion blur transformation, can each be sent to separate threads, machines, or parallelized computing systems. In embodiments, the data objects may contain sequences of transformations, such as ([motion blur, 4.5], [red shift, 5.32]).

The method (600) further includes generating test datasets 140 based on a source dataset (620). Each of the test datasets 140 corresponds to a respective test value of the set of test values for the parameter (or parameters) characterizing the particular type of data transformation (in this example, the data transformation selected by the user). In this way, the source dataset 130 and test series are used to generate data perturbation, augmentation, transformation and/or enrichment. These terms are synonymous, to a certain extent, as they all involve manipulation of the source dataset 130 to produce test datasets 140. The terms “augmentation” and “enrichment” often implies that the size of the source dataset 130 is increased in the generation of the test datasets 140.

In embodiments, the generation of new datasets, i.e., test datasets 140, may be based on the data objects, discussed above, which specify the particular type of data transformation and parameters characterizing the data transformation. This may be done using a form of parallel processing, as noted above. In generating the test datasets 140 based on the source dataset 130, the source dataset 130 may include one or more of: images, texts, tabular data, hierarchical data, graphs, videos, 3-D meshes, signals, and multidimensional arrays. In the case of a source dataset 130 containing images, test datasets 140 are generated based on selected transformations, such as motion blur and zoom, in accordance with one or more parameters quantifying the transformations. Typically, the higher the value of the parameter, the more the transformation degrades the source dataset 130 instances (i.e., images).

The method (600) further includes inputting each of the test datasets 140 to the machine learning model 110 to produce a corresponding inference, i.e., a corresponding model output (630). The method (600) further includes determining at least one score for each test dataset based at least in part on the corresponding model output (640). The model output 145 may be analyzed using various algorithms to evaluate the performance of the machine learning model 110, which may be generally described as “scoring.” For each test dataset composed of instances (e.g., images), an inference may be performed per instance (e.g., image, row, text, etc.). At a high level, this may be described as passing an input (i.e., a test dataset) to the machine learning model and collecting the outputs. In embodiments, the source dataset 130, or portion thereof, may also be scored.

In embodiments, in determining at least one score for each test dataset, a determined score may be indicative of one or more of the following evaluation metrics, i.e., measures used to quantify and evaluate machine learning model 110 performance: accuracy, F1 score, precision, dice coefficient, Jaccard Index, Log Loss, mean square error, confusion matrix, AUC-ROC, Rand Index, Mutual Information, and recall. Thus, a set of one or more scores may be indicative of a set of one or more evaluation metrics. The score (or scores) may be based at least in part on ground truth, which may be retrieved from the source dataset 130, e.g., in the form of annotations corresponding to the instances, or as a separate data structure (e.g., data file). For example, if the machine learning model 110 performs classification, then each instance may have a corresponding ground truth in the form of an annotation indicating the correct classification for that instance. In embodiments, each instance result may be scored based on the model output and target or ground truth (e.g., losses, errors, mean squared error, cross-entropy). In some cases, score results may be based on internal model information. Various types of statistics may be computed based on instance scores and other computation results. The score results, and other information, may be logged in a database, such as, for example, a relational or hierarchical database which allows for retrievals.

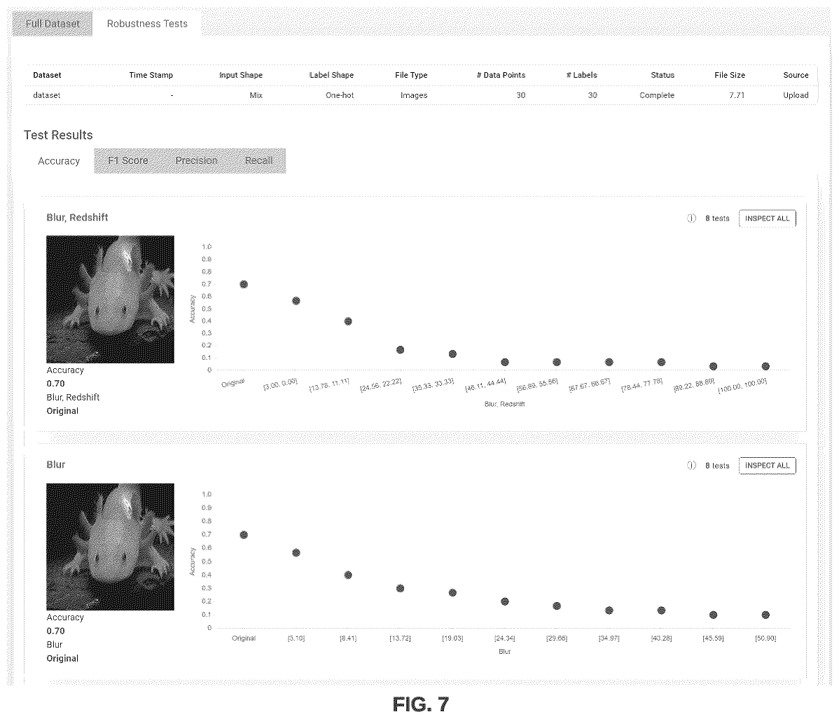

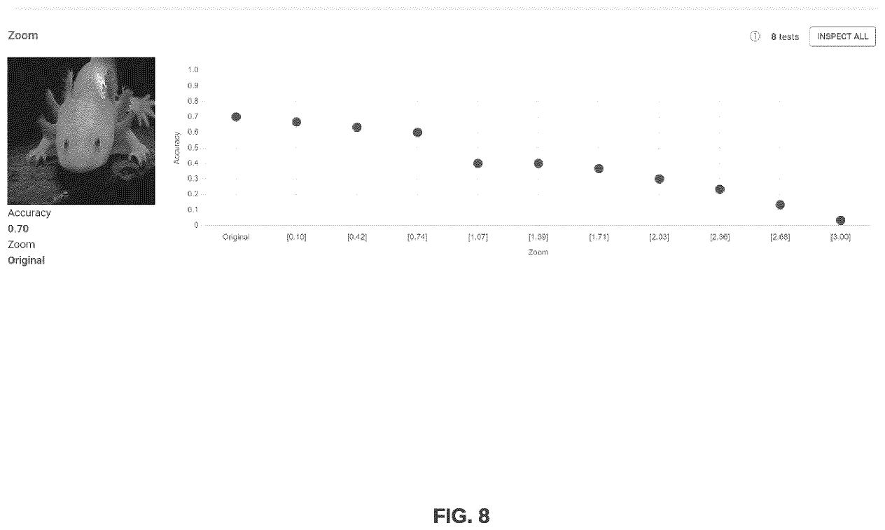

The method (600) further includes determining one or more robustness metrics of the particular type of data transformation based on a function (see, e.g., FIGS. 7 and 8) which maps the score (or scores) of each of the test datasets 140 to the parameter (or parameters) characterizing the data transformation (650). In embodiments, the robustness metrics may be determined based on an area under the function as the function is plotted versus the parameter (or parameters) characterizing the data transformation. In some cases, the area under the function may be inversely weighted relative to the parameter characterizing the data transformation to reduce the robustness metric more substantially if the function drops at the lower values of the parameter characterizing the data transformation—because a drop in the initial portion of the function indicates worse performance than, for example, a relatively flat function which drops at the higher end of the parameter values. In practice, the lower values of the parameter characterizing the data transformation often occur more frequently and commonly, and this is a further reason for penalizing an early drop more severely. In embodiments, the weighting can be defined with various other type of functions, maps and/or sequences of weights. The robustness metrics may also be determined based on one or more values of slope of the function, as the function is plotted versus the parameter (or parameters) characterizing the data transformation. The plotting of the function may be done as a calculation—which the user does not see—or as an element of the graphical user interface provided by the system 100. In the latter case, the user may glean insight from the plot (or plots) of the scores versus the pertinent parameters.

The method (600) further includes determining a set of one or more data augmentations 210 (see FIG. 2) to be applied to the source dataset 130 based at least in part on the robustness metrics of the particular type of data transformation (660). In embodiments, the robustness metrics of a first type of data transformation may be compared to robustness metrics of at least a second type of data transformation. Such a comparison may serve, in effect, to rank types of data transformation based on their influence on the performance of the machine learning model. Alternatively, or in addition to such a comparison, the robustness metrics of the particular type of data transformation may be compared to one or more thresholds. In some cases, the robustness metrics of the data transformation in question may include one or more values of the slope of the score function (or functions) plotted versus the parameter characterizing the data transformation and the values of the slope may be compared a maximum slope threshold.

The method (600) further includes generating an augmented dataset based on the source dataset 130 using the determined set of data augmentations (670), as discussed above in the context of FIG. 5, which describes the system 100 generating an augmented dataset based on the source dataset (520). In embodiments, various algorithms and processes may be used in the generation of the augmented dataset in addition to using the determined set of data augmentations. For example, the dataset may be processed to remove instances which have been found to degrade performance of the model, such as, for example, duplicate images having different and/or conflicting annotations. As a further example, a process may be used in which the model is retrained using various datasets extracted from the source and/or the augmented dataset. Furthermore, an augmented dataset from a previous iteration of the methods described herein (which may, itself, be based on the source dataset) may be used as the basis for augmentation. As explained above, the machine learning model 110 may be trained using the augmented dataset to produce a retrained machine learning model (530). The retrained machine learning model may be used to perform a task on an input dataset, and the task may include one or more of the following: prediction, classification, object detection, and clustering (540). In embodiments, in the generating of the augmented dataset based on the source dataset using the determined set of one or more data augmentations, the augmented dataset, when scored, may have one or more improved scores relative to the source dataset 130. In some cases, the augmented dataset may have an increased number of instances relative to the source dataset. Alternatively, the augmented dataset may have the same number of instances as the source dataset or fewer instances than the source dataset (e.g., if instances are algorithmically deleted from the source dataset to improve the effectiveness of the dataset).

FIGS. 7 and 8 depict plots of a function which maps values of the score for each of a number of test datasets 140 to the parameter (or parameters) characterizing the data transformation. The examples of FIG. 7 are shown as displayed by a graphical user interface. As discussed above, these plotted score functions form the basis of robustness metrics to determine a set of augmentations to be applied to a source dataset 130. The top plot on the user interface screen depicted in FIG. 7 is a plot of a score based on accuracy normalized to a unit scale. The accuracy is plotted versus two parameters characterizing a type of data transformation which combines two operations: blur and redshift. In such a case, the type of data transformation can be considered to be a combination of the two operations, e.g., blur and redshift, characterized by two parameters, e.g., one parameter characterizing the blur operation and one parameter characterizing the redshift operation. The bottom plot on the user interface screen is also a plot of a score based on accuracy normalized to a unit scale. In this case, the accuracy is plotted versus one parameter characterizing one type of data transformation: blur. FIG. 8 is a plot of a score based on normalized accuracy versus one parameter characterizing one type of data transformation: zoom. In all three plots, an accuracy of 0.70 is measured with the parameters set to zero, i.e., with the original source dataset 130. Accuracy decreases as the values of the parameters are increased, i.e., as the amount of blur and redshift, blur, or zoom, respectively, is increased.

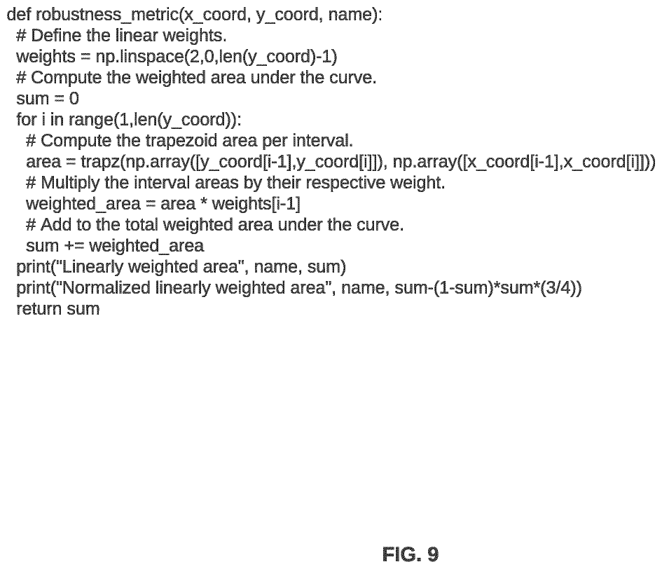

FIG. 9 depicts an example of code to determine robustness metrics using, for example, Python script. Robustness metrics can be determined based on values of slope, the area under the plotted function, or the weighted area under plotted function, among other possible combinations of slope and area of the plotted function. For example, the robustness metric may be defined as having a value between 0 and 1 (or between 0% and 100%) based on a weighted area under the plotted function, i.e., the score function. The score function, e.g., accuracy, may be plotted versus one or more parameters characterizing the data transformation, e.g., quantifying the amount of blur, redshift, and/or zoom, with both the x and y axes being normalized. In such a case, a decreasing score function, represented by a line having a slope of −0.5, would result in a robustness metric of 50%.

As discussed above, the system 100 determines a set of data augmentations to be applied to the source dataset 130 based at least in part on the robustness metrics of the particular type of data transformation (see FIG. 6, 660). In embodiments, after generating the robustness metrics, the system 100 automatically applies specific criteria and/or processes to select or generate particular types of data transformations, e.g., blur, rotation, focus, blur and redshift, new types of transformations, generated transformations, etc., to apply to the source dataset 130 to create an augmented dataset. In some cases, the selection of particular types of data transformations may depend on the initial selections made by a user in initiating the method. In embodiments, the augmented dataset is generated automatically and made available for downloading to retrain the model 110. In embodiments, the model 110 may be automatically retrained using the augmented dataset and scored.

Based on multiple experiments, it was observed that accuracy graphs that had curves which dropped rapidly, as the parameter characterizing the type of data transformation increased, would have significantly less of a decrease after performing data augmentation using the above techniques. In some cases, plots of accuracy functions for motion blur and certain other types of data transformations and data augmentation was performed (and the model retrained with the augmented dataset) would have no decrease until beyond the range of augmentation. Thus, the augmented dataset is adapted to improve the performance of the machine learning model by improving robustness metrics of the model after it has been retrained using the augmented dataset—with the objective being score functions (e.g., accuracy functions) which are substantially flat, which means a robustness approaching 100% (using certain robustness metrics algorithms).

The improvement in performance of the machine learning model arises, in part, from the augmented datasets having a wider range of properties of interest, such as blur, which, in turn, creates broader capabilities in the model due to the exposure to this broader range of training inputs. In some cases, it has been seen that the improved capabilities of the model extend beyond the range of the particular data transformation. In other words, for example, improving the detection of images blurred within a particular range of a blur parameter may also improve performance of the model for blur parameter values outside of the particular range.

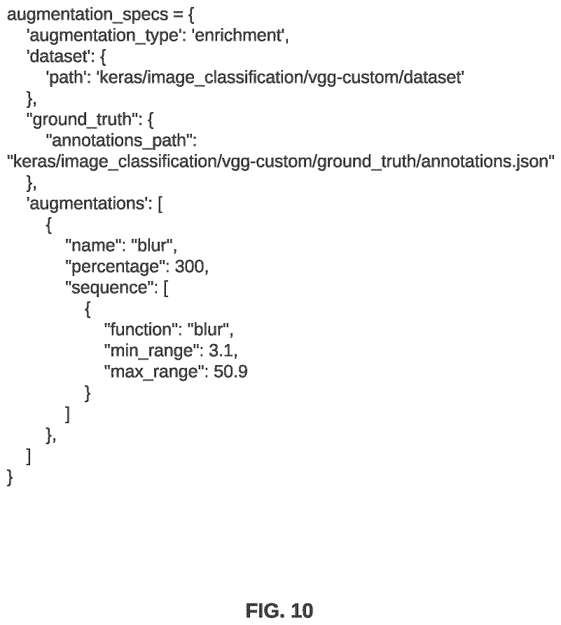

FIG. 10 depicts an example of Python code to perform dataset enrichment to generate an augmented dataset from the source dataset 130. Paths are provided to the dataset and, in some cases, to the ground truth, e.g., annotations (stored in a separate JSON datafile in this example). In the example depicted in the figure, a blur augmentation is specified in a range of 3.1 to 50.1 with a multiplicative size factor, i.e., a percentage value, of 300. This specification results in an instance, e.g., image, being randomly selected in the source dataset 130 and transformed with a blur of parameter p, where p is randomly selected in the specified range (e.g., 3.1 to 50.1), and the resulting transformed instance is added to the augmented dataset. This process of random selection and data transformation continues until the augmented dataset is—in this example—three times (i.e., 300%) the size of the source dataset 130, as specified by the size factor.

The augmented dataset generated in this manner contains the source dataset 130 as a subset thereof. Thus, the augmented dataset is, in effect, the source dataset 130 after it has been “enriched” with the newly-generated transformed instances, e.g., blurred images. If more than one type of data transformation has been specified, e.g., as in a composed test formed of multiple types of data transformations, the types of data transformation may be applied sequentially, each one potentially increasing the size of the augmented dataset resulting from the source dataset 130. In embodiments, the ground truths may be used to adjust the annotations when applying certain types of data transformations, such as, for example, rotations. In particular, if the transformation is a rotation and the annotation is a box around an object in an image, then the annotations need to be converted to follow the image rotation.

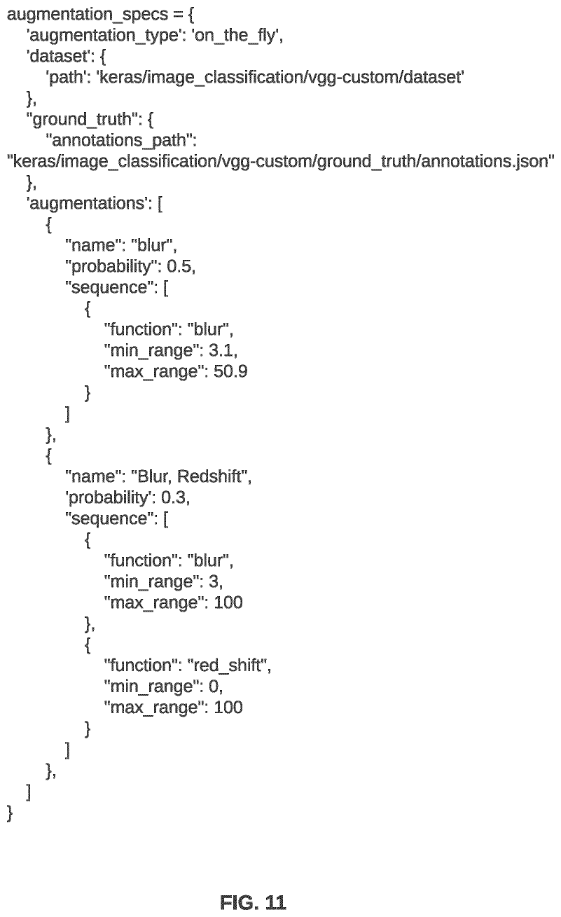

FIG. 11 depicts an example of Python code to perform on-the-fly augmentation to generate an augmented dataset from the source dataset 130. Paths are provided to the dataset and, in some cases, to the ground truth, e.g., annotations (stored in a separate JSON datafile in this example). In the example depicted in the figure, a composed sequence of three data augmentations (of two types of data augmentation) are specified: blur, followed by blur and redshift.

The blur augmentation is specified in a range of 3.1 to 50.1, with a probability factor of 0.5. This specification results in each instance, e.g., image, being selected in the source dataset 130 and transformed, or not transformed, depending on a randomized decision with a probability of 0.5 (i.e., a probability of 0.5 that the transformation will be performed). If the decision for a particular instance is to perform the data transformation, then, in this example, a blur of parameter p is applied to the particular instance, where p is randomly selected in the specified range (e.g., 3.1 to 50.1), and the resulting transformed instance in the augmented dataset, in effect, replaces the original instance from the source dataset.

The blur and redshift augmentation specifies a probability of 0.3, which means that each instance, e.g., image, being selected in the source dataset 130 and transformed, or not transformed, depending on a randomized decision with a probability of 0.3 (i.e., a probability of 0.3 that the transformation will be performed). If the decision for a particular instance is to perform the data transformation, then, in this example, a blur of parameter p is applied to the particular instance, where p is randomly selected in the specified range (e.g., 3 to 100). This is followed by a redshift of parameter q being applied to the particular instance, where q is randomly selected in the specified range (e.g., 0 to 100). The resulting transformed instance in the augmented dataset, in effect, replaces the original instance from the source dataset 130.

In embodiments, the augmented dataset may be stored as a completed dataset after all of the instances of the source dataset have been considered for transformation (which may be considered to be an epoch). Alternatively, the on-the-fly augmentation may be applied by a module as the source dataset is being input to the machine learning model.

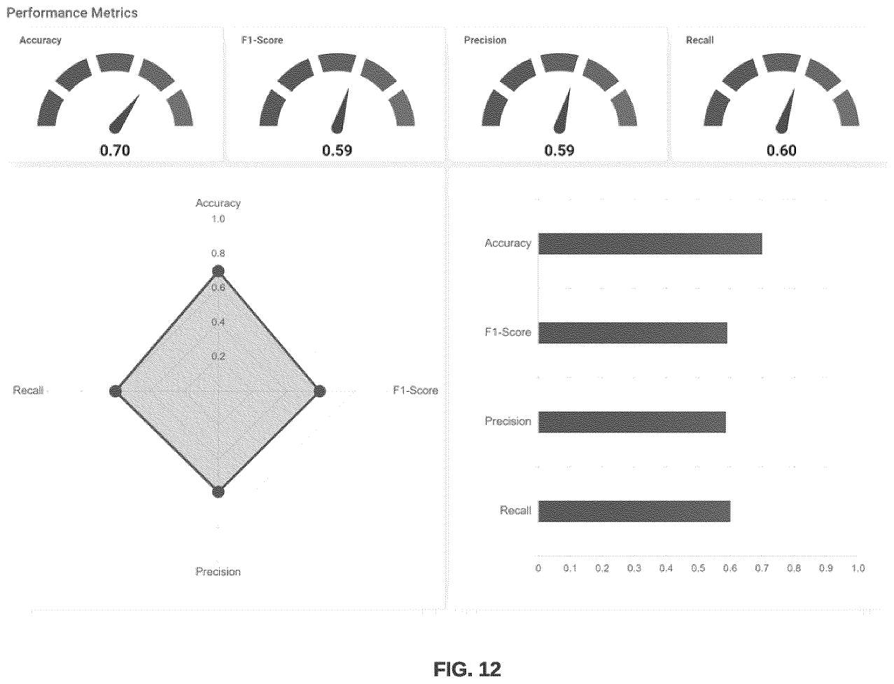

FIG. 12 depicts a graphical user interface presenting metrics for the performance of the machine learning model. The user interface provides, in graphical and/or numeric form, key performance metrics for use by data scientists and stakeholders in the domain of machine learning, such as, for example, accuracy, F1 score, precision, dice coefficient, Jaccard Index, Log Loss, mean square error, confusion matrix, AUC-ROC, Rand Index, Mutual Information, and recall. Various other types of metrics may also be displayed, such as average model attention per class.

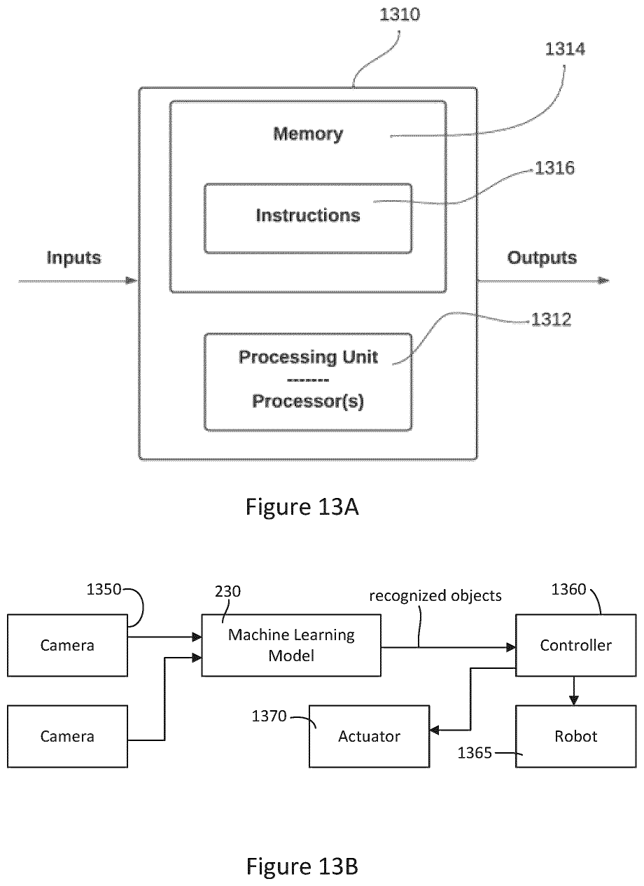

FIG. 13A is a block diagram of an example of a computing system usable to implement methods described herein. The method(s) described herein may be implemented by a computing system 1310, comprising at least one processing unit 1312 and at least one memory 1314 which has stored therein computer-executable instructions 1316. In embodiments, the methods described herein may be implemented by a system or network comprising a plurality of computing systems, such as the computing system 1310. The processing unit 1312 may comprise one or more processors or any other suitable devices configured to implement the method(s) described herein such that instructions 1316, when executed by the computing system 1310 or other programmable apparatus, may cause the method(s) described herein to be executed. Furthermore, such computing systems may provide for the method(s) described herein to be executed using separate threads, machines, processors, processor cores, and/or other forms of parallelized computing. The processing unit 1312 may comprise, for example, any type of general-purpose or specialized microprocessor or microcontroller, a digital signal processing (DSP) processor, a central processing unit (CPU), a graphical processing unit (GPU), an integrated circuit, a field programmable gate array (FPGA), a reconfigurable processor, other suitably programmed or programmable logic circuits, or any combination thereof. The processing unit 1312 may be referred to as a “processor” or a “computer processor”.

The memory 1314 may comprise any suitable machine-readable storage medium. The memory 1314 may comprise non-transitory computer readable storage medium, for example, but not limited to, an electronic, magnetic, optical, electromagnetic, infrared, or semiconductor system, apparatus, or device, or any suitable combination of the foregoing. The memory 1314 may include a suitable combination of any type of computer memory that is located either internally or externally to the device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1314 may comprise any storage means (e.g., devices) suitable for retrievably storing machine-readable instructions 1316 executable by processing unit 1312.

The methods and systems described herein may be implemented in a high-level procedural or object-oriented programming or scripting language, or a combination thereof, to communicate with or assist in the operation of a computer system, for example the computing system 1310. Alternatively, or in addition, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the methods described herein. Embodiments of the methods and systems described herein may also be considered to be implemented by way of a non-transitory computer-readable storage medium having a computer program stored thereon. The computer program may comprise computer-readable instructions which cause a computer, or in some embodiments the processing unit 1312 of the computing system 1310, to operate in a specific and predefined manner to perform the methods described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

FIG. 13B shows a computer vision system used in product manufacturing. One or more cameras 1350 acquire images of a product or of a component of a product during manufacturing. The images acquired by camera 1350 are processed using the machine learning model (computer vision object recognition using the machine learning model) 230 that has been retrained using the augmented dataset or datasets as described above. The ML model 230 output signals the recognition of objects which can then be used by a controller 1360 to modify the operation of a robot 1365 used in the manufacture of a product and/or an actuator 1370 to reject a component or product that is not suitable for release or use.

It will be appreciated that cameras 1350 are used in the context of computer vision, however, product manufacturing may also use machine learning using non-imaging sensors to acquire signals during manufacturing. Such sensors may measure thicknesses, weight, dimensions, densities (e.g., X-ray), rigidity, uniformity (e.g., ultrasound), or any other suitable physical property of a part, component or assembled product. The sensor signal or signals may be processed using the machine learning model that has been retrained using the augmented dataset or datasets as described above. Such augmentation can be accomplished for any type of signal (ex. time series, tabular, images, videos, text). The machine learning model may output signals that can then be used by a controller to modify the operation of a robot, conveyor or processing machine used in the manufacture of a product and/or an actuator to modify the manufacturing machine behavior or reject a component or product that is not suitable for release or use.

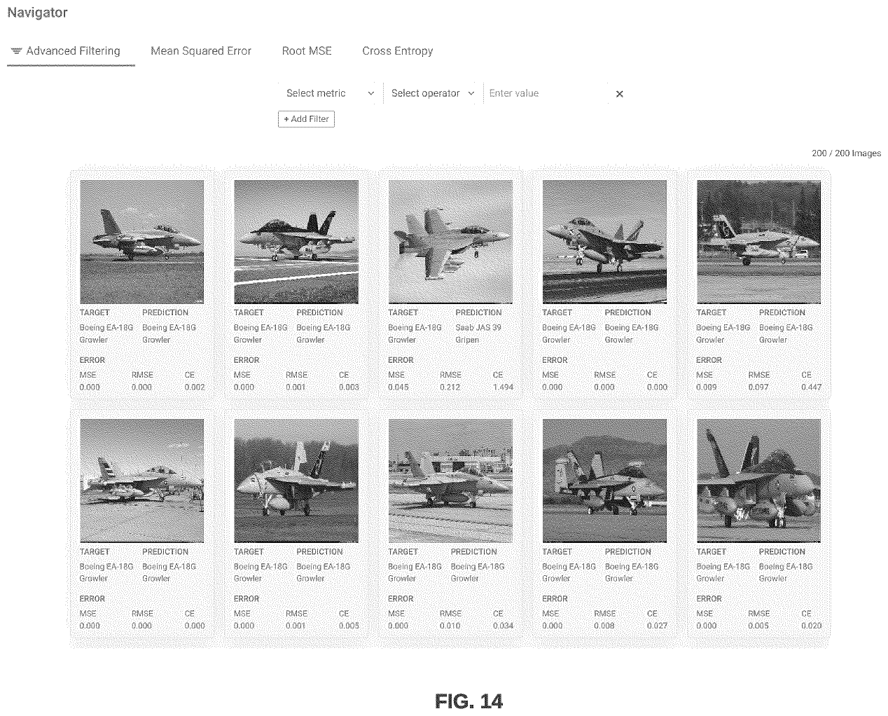

FIG. 14 depicts a graphical user interface showing navigation and filtering of instances (e.g., images) of a dataset. Via the user interface, a user can enter filtering parameters to filter instances of a dataset, e.g., a test dataset, to access selected instances or sets of instances. In the example depicted in the figure, the user could search for particular types of aircraft to review the instances and access their individual details.

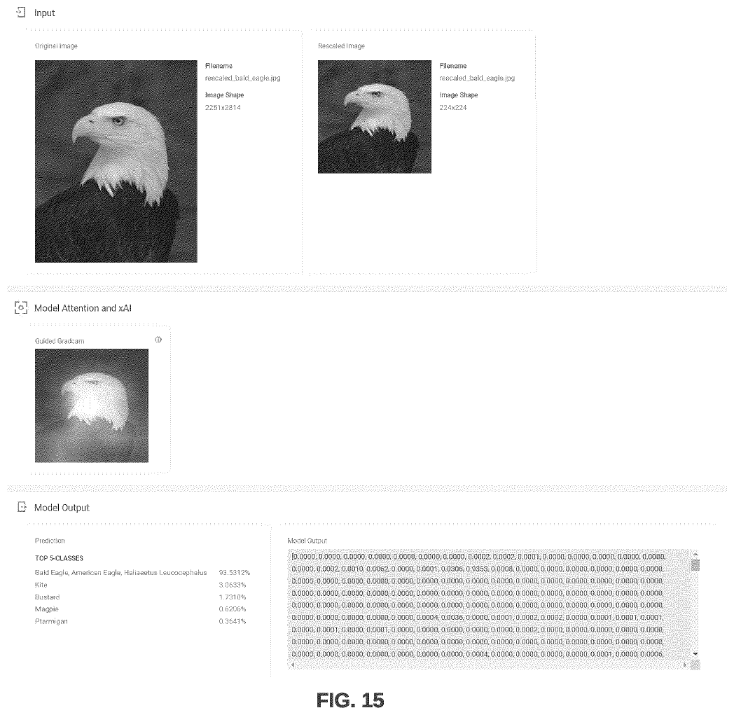

FIG. 15 depicts a graphical user interface showing detailed information for a particular instance of a dataset. Via the user interface, the user can access an individual instance, e.g., an instance selected from the navigation and filtering user interface discussed above. The user can analyze the behavior of that instance in the model from the standpoint of model attention and explainable AI (xAI) (e.g., Gradcam), as well as other metrics, to assess the performance of the particular instance. For example, the user interface shows the model output for the particular instance, as well as the entire model output vector for that instance.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

1. A method to produce, using at least one computer having one or more processors and memory, an augmented dataset to improve performance of a machine learning model, the method comprising:
creating a test series for a first type of data transformation, the test series defining a set of test values for at least one parameter characterizing the first type of data transformation;
generating test datasets based on a source dataset, each of the test datasets corresponding to a respective test value of the set of test values for said at least one parameter characterizing the first type of data transformation;
inputting each of the test datasets to the machine learning model to produce a corresponding model output;
determining at least one score for each test dataset based at least in part on the corresponding model output;
determining one or more robustness metrics of the first type of data transformation based on a function which maps said at least one score of each of the test datasets to said at least one parameter characterizing the first type of data transformation;
determining a set of one or more data augmentations to be applied to the source dataset based at least in part on said one or more robustness metrics of the first type of data transformation; and
generating an augmented dataset based on the source dataset using the determined set of one or more data augmentations.

2. The method of claim 1, wherein, in said creating the test series for the first type of data transformation, the set of test values is defined by a selected range minimum, a selected range maximum, and a selected number of intervals of said at least one parameter.

3. (canceled)

4. The method of claim 1, wherein, in said creating the test series for the first type of data transformation, the test series comprises data objects, each of the data objects specifying the first type of data transformation and including said at least one parameter characterizing the first type of data transformation, wherein values of said at least one parameter in the data objects define the set of test values.

5. The method of claim 1, wherein, in said creating the test series for the first type of data transformation, the first type of data transformation is in one or more of the following categories: blur, color correction, domain adaptation, zoom, weather, noise, translation, rotation, occlusion, enhancement, pixel attack, ethics, drift, statistics, and explainable artificial intelligence (xAI).

6. The method of claim 1, wherein, in said creating the test series for the first type of data transformation, the first type of data transformation comprises one or more of the following: rotate, blur, random shadow, sharpen and darken, random grid shuffle, gaussian noise, motion blur, horizontal flip, vertical flip, horizontal and vertical flip, sun flare, contrast raise, brightness raise, brightness reduce, desert domain adaptation, winter domain adaptation, jungle domain adaptation, red shift, green shift, blue shift, yellow shift, magenta shift, cyan shift, translate horizontal, translate vertical, translate horizontal reflect, translate vertical reflect, shot noise, impulse noise, defocus blur, snow, frost, fog, brightness, contrast, elastic transform, pixelate, jpeg compression, day-to-night, night-to-day, zoom center, zoom right, zoom left, zoom top, zoom bottom, zoom right bottom, zoom right top, zoom left bottom, and zoom left top.

7. The method of claim 1, wherein in said generating the test datasets based on the source dataset, the source dataset comprises one or more of: images, texts, tabular data, hierarchical data, graphs, videos, 3-D meshes, signals, and multidimensional arrays.

8. The method of claim 1, wherein, in said determining said at least one score for each test dataset, said at least one score is indicative of one or more of the following: accuracy, F1 score, precision, and recall.

9. The method of claim 1, wherein, in said determining said at least one score for each test dataset, said at least one score is based at least in part on ground truth, said ground truth is retrieved from the source dataset.

10. (canceled)

11. (canceled)

12. The method of claim 1, wherein, in said determining said one or more robustness metrics of the first type of data transformation, said one or more robustness metrics are determined based on an area under the function as the function is plotted versus said at least one parameter characterizing the first type of data transformation.

13. The method of claim 12, wherein the area under the function is inversely weighted relative to said at least one parameter characterizing the first type of data transformation to reduce the robustness metric more substantially if the function decreases at lower values of said at least one parameter characterizing the first type of data transformation.

14. The method of claim 1, wherein, in said determining said one or more robustness metrics of the first type of data transformation, said one or more robustness metrics are determined based on one or more values of slope of the function as the function is plotted versus said at least one parameter characterizing the first type of data transformation.

15. The method of claim 1, wherein, in said determining the set of one or more data augmentations to be applied to the source dataset based at least in part on said one or more robustness metrics of the first type of data transformation, one or more processes are used to augment the source data set, the augmented dataset is used to retrain the machine learning model, and, if performance of the model increases, then the augmented dataset is used as the source data set in a further iteration.

16. The method of claim 1, wherein, in said determining the set of one or more data augmentations to be applied to the source dataset based at least in part on said one or more robustness metrics of the first type of data transformation, said one or more robustness metrics of the first type of data transformation are compared to (a) one or more robustness metrics of at least a second type of data transformation, or (b) one or more thresholds, wherein said one or more robustness metrics of the first type of data transformation comprise said one or more values of the slope of the function plotted versus said at least one parameter characterizing the first type of data transformation and said one or more values of the slope are compared a maximum slope threshold.

17. (canceled)

18. (canceled)

19. The method of claim 1, wherein, in said determining a set of one or more data augmentations to be applied to the source dataset based at least in part on said one or more robustness metrics of the first type of data transformation, the set of one or more data augmentations comprises at least one type of data transformation in addition to any type of data transformation input or selected by a user.

20. The method of claim 1, wherein, in said generating the augmented dataset based on the source dataset using the determined set of one or more data augmentations, the augmented dataset has one or more improved scores relative to the source dataset.

21. The method of claim 1, further comprising processing the augmented dataset to remove one or more instances which have been found to degrade performance of the model, resulting in fewer instances than the source dataset, to improve one or more scores relative to the source dataset.

22. (canceled)

23. (canceled)

24. The method of claim 1, further comprising training the machine learning model using the augmented dataset to produce a retrained machine learning model, and using the retrained machine learning model to perform on an input dataset one or more of the following: prediction, classification, object detection, and clustering.

25. (canceled)

26. A method of manufacturing a product comprising:
acquiring at least one image of at least one component of the product;
using said at least one image as said input dataset to perform object detection as defined in claim 24;
controlling one of a manufacturing robot and a manufacturing actuator using said object detection.

27. A system to produce an augmented dataset to improve performance of a machine learning model, the system comprising at least one computer having one or more processors and memory, the memory storing instructions that, as a result of execution by the one or more processors, cause the one or more processors to perform the method of claim 1.

28. A non-transitory computer-readable storage medium having instructions stored thereon that, when executed, cause at least one computer processor to perform the method of claim 1.
